(19) United States
(12) Patent Application Publication
(10) Pub. No.: US 2019/0232678 A1
(43) Pub. Date: Aug. 1, 2019

(54) PRINTING DEVICE AND PRINTING METHOD

(71) Applicant: MIMAKI ENGINEERING CO., LTD., Nagano (JP)

(72) Inventor: Masaru Ohnishi, Nagano (JP)

(73) Assignee: MIMAKI ENGINEERING CO., LTD., Nagano (JP)

(21) Appl. No.: 16/255,848

(22) Filed: Jan. 24, 2019

(30) Foreign Application Priority Data
Jan. 29, 2018 (JP) 2018-012228

(51) Int. Cl. B41J 2/21; B41J 2/14; B41J 11/00

(52) U.S. Cl. CPC B41J 2/2107; B41J 11/002; B41J 2/14008

(57) ABSTRACT

To perform colorful printing more appropriately, a printing apparatus (10) configured to print by inkjet includes: a plurality of inkjet heads (102), a main scanning driver (16), and a sub scanning driver (18). When a row in which one or more inkjet heads (102) are arranged side by side in a main scanning direction is defined as a head row (202), the inkjet heads (102) are arranged so as to form a plurality of the head rows (202). The printing apparatus includes, as the inkjet heads (102), inkjet heads (102) for primary colors and inkjet heads (102) for secondary colors. The printing apparatus includes a dark ink head and a light ink head for at least one of red and blue as the inkjet heads for secondary colors. For the red or the blue, the dark ink head and the light ink head are arranged in different head rows (202).

### CROSS REFERENCE TO RELATED APPLICATIONS

This application claims the priority of Japan patent application serial no. 2018-012228, filed on Jan. 29, 2018. The entirety of the above-mentioned patent application is hereby incorporated by reference herein and made a part of this specification.

### TECHNICAL FIELD

The present disclosure relates to a printing apparatus and a printing method.

### BACKGROUND ART

Conventionally, inkjet printers configured to perform inkjet printing are widely used. Also known is a configuration of an inkjet printer that uses light shade of ink, in which color density is lower than that of ink having regular density, for cyan color and magenta color (See, for example, Patent Literature 1).

Patent Literature 1: Japanese Unexamined Patent Publication No. 2000-62153

### SUMMARY

As a method for color printing by inkjet, a method (four-color separation) using four colors of inks of yellow (Y), magenta (M), cyan (C), and black (K) (basic four-color ink) has been conventionally widely used. In recent years, a method (seven-color separation) for printing with seven colors of inks has been studied, in which red (R), green (G), and blue (B) are added to the four colors of YMCK. In this case, the use of ink of the RGB colors contributes to performing colorful printing more appropriately. With this method, each of the RGB colors can be represented without ink of a plurality of colors being mixed, and thus an amount of ink to be landed (landed amount) at each position on a print medium (media) can be reduced. In this case, bleeding is less likely to occur, and hence high-speed printing can be performed more appropriately.

However, there remains many issues to be studied further on the configuration of printing such as the one that uses the RGB colors of ink. Thus, printing with more appropriate configuration has been desired for the case using the RGB colors of ink, for example. It is, therefore, an object of the present disclosure to provide a printing apparatus and a printing method that can solve the above-mentioned problem.

The inventors of the present disclosure conducted diligent studies on the case where ink of secondary colors is used in addition to ink of primary colors serving as basic colors in subtractive color mixing, such as seven-color separation. In this case, the primary colors are, for example, the YMC colors. The secondary colors are colors obtained in principle by mixing a plurality of primary colors, such as the RGB colors.

Through the diligent studies, the inventors of the present disclosure have found that the use of secondary colors can make granularity (graininess, granularization) more conspicuous in print results. The inventors of the present disclosure consider that this phenomenon occurs because dots of ink of secondary colors look darker than dots of ink of primary colors. More specifically, ink of primary colors, which are basic colors in subtractive color mixing, has characteristics of absorbing light in a predetermined wavelength range. As described above, the secondary colors are colors obtained in principle by mixing a plurality of primary colors. In this case, a wavelength range where ink of secondary colors absorbs light is considered to be the combined range of wavelengths where each of primary colors to be mixed absorbs light. As a result, an amount of light reflected in dots of ink of secondary colors becomes smaller than that of light reflected in dots of ink of primary colors. In this case, because the amount of reflected light is reduced, the dots of ink of secondary colors look darker because a brightness is lower than that of the dots of ink of primary colors.

Thus, the inventors of the present disclosure conceived of using, in addition to dark ink (dark color ink), which has normal color density, light ink (light-color ink), which is lighter than the dark ink, as the ink of secondary colors. With such a configuration, for example, the light ink can be used to print on a region to represent light colors, thereby appropriately preventing the granularity from being conspicuous. The inventors of the present disclosure found in this case that ink of R color and B color in the secondary colors makes the granularity conspicuous. Thus, the inventors of the present disclosure conceived of using light ink for the R color or the B color.

In this case, however, if light ink is simply used, a total amount of ink ejected to a unit area on a medium per unit time can be excessive. As a result, bleeding may easily occur, and it may be difficult to print at high speed. On the other hand, the inventors of the present disclosure conducted further diligent studies to conceive of not simply using light ink for secondary colors, such as R color and B color, but arranging inkjet heads for dark ink (dark ink heads) and inkjet heads for light ink (light ink heads) with positions shifted in a sub scanning direction such that regions where ink is ejected are shifted in each main scanning operation. With such a configuration, for example, even when light ink for secondary colors is used, a total amount of ink ejected to a unit area on a medium per unit time can be appropriately prevented from being excessive.

The inventors of the present disclosure found features necessary for obtaining such effects, and came up with the present disclosure. In order to solve the above-mentioned problems, the present disclosure provides a printing apparatus configured to print on a medium by inkjet, including: a plurality of inkjet heads, configured to eject ink to the medium; a main scanning driver, configured to control the inkjet heads to perform a main scanning operation of ejecting ink while moving relatively to the medium in a main scanning direction set in advance; and a sub scanning driver, configured to control the inkjet heads to perform a sub scanning operation of moving relatively to the medium in a sub scanning direction orthogonal to the main scanning direction. When a row in which one or more inkjet heads are arranged side by side in the main scanning direction is defined as a head row, the inkjet heads are arranged so as to form a plurality of the head rows in which positions in the sub scanning direction are shifted. The printing apparatus includes at least inkjet heads for primary colors and inkjet heads for secondary colors as the inkjet heads. The primary colors are basic colors that enable color representation in principle by subtractive color mixing. The secondary colors are colors obtained by mixing a plurality of the primary colors in principle. The printing apparatus includes a dark ink head and a light ink head for at least one of red and blue as the inkjet heads for the secondary colors, the dark ink head being an inkjet head configured to eject ink of a relatively dark color, the light ink head being an inkjet head configured to eject ink of a relatively light color. For the red or the blue, the dark ink head and the light ink head are arranged in different head rows.

With such a configuration, printing is performed by using ink of primary colors and secondary colors, and hence, for example, colorful printing can be performed more appropriately. In this case, by using light ink for at least one of red (R) and blue (B), the granularity can be appropriately prevented from being conspicuous. In addition, by arranging light ink heads for secondary colors in a head row different from that of dark ink heads of the same color, the ink heads can be appropriately arranged such that the positions in the sub scanning direction are shifted. Consequently, for example, even when light ink for secondary colors is used, the total amount of ink ejected to a unit area on a medium per unit time can be appropriately prevented from being excessive. In this case, the total amount of ink is reduced, and hence, for example, ink bleeding can be prevented from easily occurring. Because ink bleeding is less likely to occur, for example, high-speed printing can be performed more appropriately. Thus, with such a configuration, for example, colorful and high-speed printing can be performed more appropriately.

Regarding dark ink, a relatively dark color is a color darker than light ink for the same color. Regarding light ink, a relatively light color is a color lighter than dark ink for the same color. In this configuration, as ink ejected by each of the inkjet heads, for example, evaporation-drying ink can be preferably used. Examples of the evaporation-drying ink include ink that evaporates a solvent in order to be fixed on a medium. In this case, for example, ink of each color includes a colorant and a solvent. It is preferred that the printing apparatus further include a drying device (for example, heater) configured to dry ink. In this case, the drying device can be considered as an example of a fixing device configured to fix ink.

In this configuration, for example, inkjet heads in each head row are arranged such that positions in the sub scanning direction do not overlap with those of inkjet heads in another head row. As light ink heads for secondary colors, for example, it is preferred that the head include light ink heads for both of the R color and the B color. In this configuration, as ink of primary colors, for example, ink of colors of yellow (Y), magenta (M), and cyan (C) can be preferably used. As ink of secondary colors, ink of colors of red (R), green (G), and blue (B) can be preferably used. In this case, secondary colors can be considered as, for example colors obtained by mixing two kinds of primary colors. In this configuration, for example, the printing apparatus performs printing by seven-color separation using at least seven colors of ink. In this case, the printing apparatus further includes a black head that is an inkjet head configured to eject black ink. In this case, black ink can be considered as ink of a tertiary color.

When black ink is used for printing, in particular, dots of black ink cause more conspicuous granularity than ink of other colors. Thus, when black ink is used, it is preferred that the printing apparatus include a dark ink head and a light ink head as black heads. With such a configuration, for example, the granularity can be appropriately prevented from being conspicuous in print results. When light ink is used for black ink, in general, it is less frequent that dark ink and light ink of black are ejected to the same position on the medium. Thus, even when a dark ink head and a light ink head for black ink are arranged in the same head row, the total amount of ink ejected to a unit area on the medium per unit time is less likely to be excessive. Thus, the dark ink head and the light ink head for black ink may be arranged in the same head row.

To perform colorful printing more appropriately while appropriately preventing the granularity from being conspicuous, it is preferred to use light ink for all secondary colors. In this case, for example, the printing apparatus includes, as inkjet heads for secondary colors, dark ink heads and light ink heads for at least RGB colors. In this case, it is preferred that a dark ink head and a light ink head for the same color be arranged in different head rows. More specifically, in this case, for the RGB colors, the dark ink head and the light ink head for the same color may be arranged in different head rows. With such a configuration, for example, colorful printing can be performed more appropriately while preventing bleeding from occurring and the granularity from being conspicuous.

In this case, dark ink heads for secondary colors may be arranged in one head row, and light ink heads for secondary colors may be arranged in another head row. More specifically, in this case, for example, dark ink heads for RGB colors are arranged in the same head row. Light ink heads for RGB colors are arranged in the same head row different from that of the dark ink heads. With such a configuration, for example, the inkjet heads for secondary colors can be appropriately arranged while preventing a number of head rows from being too large.

In this case, in order to arrange inkjet heads in a more compact manner, inkjet heads for primary colors may be arranged in the same head row as that of any of inkjet heads for secondary colors. More specifically, in this case, at least one of inkjet heads for primary colors may be arranged in the same head row as that of dark ink heads for RGB colors. At least any of inkjet heads for primary colors may be arranged in the same head row as that of light ink heads for RGB colors. In this case, all inkjet heads for primary colors may be arranged in the same head row as that of dark ink heads for RGB colors or light ink heads for RGB colors. With these configurations, for example, even when a large number of inkjet heads are used, the inkjet heads can be arranged in a more compact manner.

In this case, it is preferred that the inkjet heads included in the printing apparatus be arranged separately in four or less head rows. The inkjet heads included in the printing apparatus are, for example, all inkjet heads used for printing in the printing apparatus. It is more preferred that the number of head rows be three or less. With such a configuration, for example, the number of head rows can be appropriately prevented from being too large.

To more reliably prevent the granularity from being conspicuous, it is preferred to use dark ink and light ink for ink of every color used for printing. In this case, however, the number of inkjet heads may be too large, the printing apparatus may be upsized, and a cost thereof may increase. On the other hand, as described above, the granularity in print results is assumed to be particularly conspicuous when using secondary colors. Thus, to prevent the number of inkjet heads from being too large, for example, rather than using light ink and dark ink, only ink (for example, dark ink) having one kind of density may be used for primary colors. More specifically, in this case, the printing apparatus includes, as inkjet heads for primary colors, for example, inkjet heads configured to eject ink of different primary colors. As an inkjet head for each of the primary colors, the printing apparatus includes only an inkjet head for ink having one kind of density.

Preferred arrangements of inkjet heads can be discussed, for example, in relation to the amount of ink ejected onto a medium. For example, when a total of amounts of ink ejected to positions on a medium during one main scanning operation is defined as a main scanning ink amount, and when a main scanning ink amount for ejecting ink once to every ejection position of ink set in accordance with a printing resolution is defined as a main scanning ink amount of 100%, the arrangement of the inkjet heads forming for example, the head rows may allow the inkjet heads to reduce the maximum main scanning ink amount. In this case, it is preferred to arrange the inkjet heads such that the maximum main scanning ink amount is 100% or less. With such a configuration, for example, the total amount of ink ejected to a unit area on a medium per unit time can be appropriately prevented from being excessive.

To prevent the granularity from being conspicuous, a volume of ink ejected from an inkjet head may be set variable to form small-size dots of ink, in addition to the method using light ink. Thus, in this configuration, as an inkjet head for at least a part of colors, an inkjet head (ejection volume variable head) capable of setting at least two kinds of volumes as the volume of ejected ink may be used. More specifically, for example, an ejection volume variable head may be used as at least one of inkjet heads for primary colors. In this case, for example, an ejection volume variable head may be used as an inkjet head for a color for which light ink is not used. With such a configuration, for example, the granularity can be appropriately prevented from being conspicuous while preventing the number of inkjet heads from being too large.

As a configuration of the present disclosure, a printing method having the same features as those described above may be used. In this case, for example, the same effects as those described above can be obtained.

According to the present disclosure, for example, colorful printing can be performed more appropriately.

### BRIEF DESCRIPTION OF THE DRAWINGS

FIG. 1 including FIGS. 1A to 1C, are diagrams illustrating an example of a printing apparatus 10 according to one embodiment of the present disclosure. FIG. 1A illustrates an example of a configuration of a main part of the printing apparatus 10. FIG. 1B illustrates an example of a configuration of a head 12. FIG. 1C illustrates an example of a configuration of inkjet heads included in the head 12.

FIG. 2 illustrates an example of various configurations of the head 12.

FIG. 3 illustrates an example of various configurations of the head 12.

FIG. 4 illustrates an example of various configurations of the head 12.

FIG. 5 illustrates an example of various configurations of the head 12.

FIG. 6 is a diagram for describing examples of a color expressed by mixing of a plurality of colors of inks.

FIG. 7 is a diagram for describing a total amount of ink ejected to a unit area on a medium per unit time.

FIG. 8 is a diagram for describing a maximum landed ink amount in a case where light ink having a lower color density is used.

FIG. 9 is a diagram for describing a maximum landed ink amount in a case where light ink having a lower color density is used.

### DESCRIPTION OF EMBODIMENTS

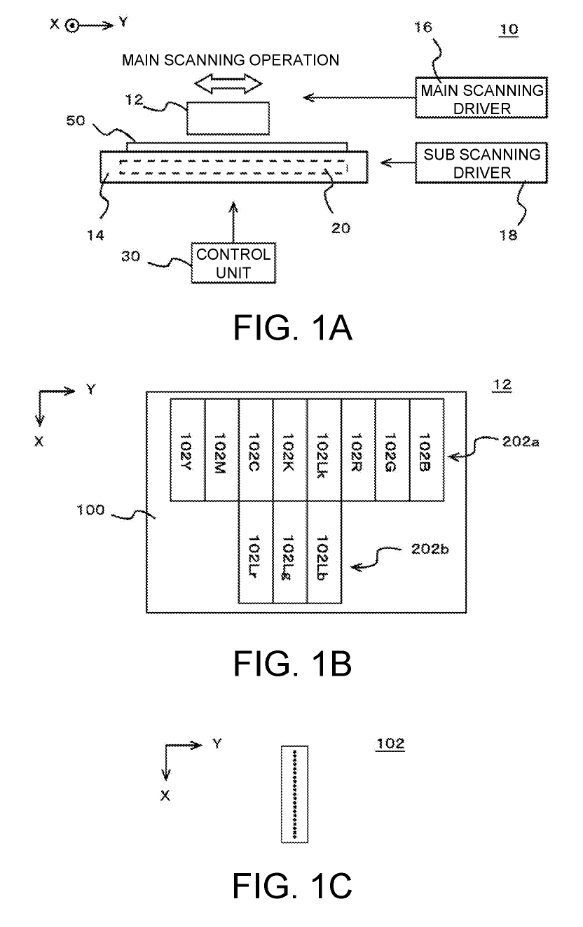

Embodiments of the present disclosure are described below with reference to the accompanying drawings. FIG. 1 illustrate an example of a printing apparatus 10 according to one embodiment of the present disclosure. FIG. 1A illustrates an example of a configuration of a main part of the printing apparatus 10. In the present example, the printing apparatus 10 is an inkjet printer configured to print on a medium (media) 50 to be printed by inkjet, and includes a head 12, a platen 14, a main scanning driver 16, a sub scanning driver 18, a heater 20, and a control unit 30. In the present example, the printing apparatus 10 uses ink of seven colors to perform full-color printing on the medium 50. Except for points described below, the printing apparatus 10 may have the same or similar features as those of publicly known inkjet printers. For example, the printing apparatus 10 may further have the same or similar configurations as those of publicly known inkjet printers in addition to the illustrated configurations of the main part.

The head 12 is a portion configured to eject ink of a plurality of colors to the medium 50 and has a plurality of inkjet heads. In the present example, evaporation-drying ink is used as ink ejected by each of the inkjet heads in the head 12. Examples of the evaporation-drying ink include ink that evaporates a solvent in order to be fixed on a medium. In this case, for example, ink of each color includes a colorant and a solvent. More specific configurations of the head 12 are described in more detail later. The platen 14 is a trapezoidal member configured to support the medium 50 and places the medium 50 on its top surface at a position opposed to the head 12. As a result, the platen 14 supports the medium 50 so as to be opposed to the head 12.

The main scanning driver 16 is a driver configured to control the head 12 to perform a main scanning operation. In this case, to control the head 12 to perform main scanning operation is to control the inkjet heads included in the head 12 to perform main scanning operation. Examples of the main scanning operation include operation of ejecting ink while moving relatively to the medium 50 in a main scanning direction set in advance. In the present example, the main scanning direction is a direction parallel to a Y direction illustrated in the figures. The main scanning driver 16, for example, controls the head 12 to perform main scanning operation by moving the head 12 while fixing the position of the medium 50 in the main scanning direction. The main scanning driver 16 may control the head 12 to perform main scanning operation by moving the medium 50 while fixing the position of the head 12 in the main scanning direction.

The sub scanning driver 18 is a driver configured to control the head 12 to perform a sub scanning operation. In this case, to control the head 12 to perform sub scanning operation is to control the inkjet heads included in the head 12 to perform sub scanning operation. Examples of the sub scanning operation include operation of moving relatively to the medium 50 in a sub scanning direction orthogonal to the main scanning direction. In the present example, the sub scanning direction is a direction parallel to an X direction illustrated in the figures. The sub scanning driver 18, for example, controls the head 12 to perform sub scanning operation between an interval of the main scanning operation, thereby sequentially changing a region of the medium 50 opposed to the head 12. The sub scanning operation, for example, can be considered as a feed operation of feeding the medium 50 relatively to the head 12. The sub scanning driver 18, for example, controls the head 12 to perform sub scanning operation by moving the medium 50 while fixing the position of the head 12 in the sub scanning direction. In this case, for example, a roller may be used to convey the medium 50 in a conveying direction parallel to the sub scanning direction. The sub scanning driver 18 may control the head 12 to perform sub scanning operation by moving the head 12 while fixing the position of the medium 50 in the sub scanning direction.

The heater 20 is a heating device configured to heat the medium 50 and is disposed in the platen 14 to heat the medium 50 at a position opposed to the head 12 or in its vicinity. As a result, the heater 20 evaporates a solvent in ink adhered on the medium 50, so that ink is fixed on the medium 50. In this case, the heater 20 can be considered as an example of a drying device configured to dry ink.

Another configuration than the heater 20, for example, may be used as the drying device. In the case where ink that generates heat when irradiated with energy rays such as ultraviolet rays is used as ink, for example, an irradiation unit configured to irradiate ink with energy rays may be used as the drying device. In this case, examples of ink that generates heat when irradiated with energy rays include ink that generates heat by itself when irradiated with energy rays such that a viscosity of ink increases to a viscosity that causes at least no bleeding. The energy ray irradiation unit, for example, is disposed in the head 12 to irradiate ink with energy rays immediately after landed on the medium 50. Such ink can be considered, for example, as fast-drying ink that dries instantly when irradiated with energy rays. In this case, the energy ray irradiation unit irradiates ink with energy rays such that a temperature of ink increases to, for example, a temperature of 80% or more of a boiling point of a solvent in the ink. The energy ray irradiation unit may irradiate ink with energy rays to boil a solvent in the ink. As such fast-drying ink, for example, ink containing an absorber (for example, ultraviolet ray absorber) that absorbs energy rays can be preferably used. When ultraviolet rays are used as energy rays, for example, such ink can be considered as ink (UV fast-drying ink) that dries instantly when irradiated with ultraviolet rays. For example, the heater 20 and the energy ray irradiation unit can be considered as an example of a fixing device configured to fix ink to the medium 50. In the printing apparatus 10, as ink, for example, ink (for example, UV curable ink) other than evaporation-drying ink may be used. In this case, it is preferred that the printing apparatus 10 include a fixing device corresponding to the type of ink to be used.

The control unit 30 is, for example, a CPU in the printing apparatus 10, and controls operation of the units in the printing apparatus 10. According to the present example, for example, appropriate printing can be performed on the medium 50.

Subsequently, a more specific configuration of the head 12 is described. FIG. 1B illustrates an example of a configuration of the head 12. FIG. 1C illustrates an example of a configuration of the inkjet heads included in the head 12. As described above, in the present example, the head 12 includes inkjet heads. More specifically, in the present example, the head 12 includes a carriage 100 and inkjet heads 102. The carriage 100 is a holding member configured to hold the inkjet heads 102, and as illustrated in FIG. 1B, holds the inkjet heads 102 side by side. In FIG. 1B, the inkjet heads 102 included in the head 12 are illustrated with symbols representing colors of ink ejected by the corresponding inkjet heads 102, such as 102Y to 102Lb.

In this case, the same inkjet heads can be preferably used as the inkjet heads 102 in the head 12. In this case, the same inkjet heads mean that, for example, the inkjet heads have the same design structure. More specifically, the same inkjet heads mean that, for example, the inkjet heads have the same model number. In this case, as the inkjet head 102, for example, an inkjet head in which a plurality of nozzles are arranged side by side in the sub scanning direction as illustrated in FIG. 1C may be used. The configuration in which the nozzles are arranged side by side in the sub scanning direction means, for example, a configuration in which the nozzles are arranged side by side in the sub scanning direction in a state of being mounted to the printing apparatus 10.

In the present example, the head 12 has inkjet heads for seven different colors of yellow (Y), magenta (M), cyan (C), black (K), red (R), green (G), and blue (B). For K color and RGB colors of these colors, the head 12 has inkjet heads having different color densities. More specifically, in the configuration illustrated in FIG. 1B, an inkjet head 102Y is an inkjet head 102 for Y color. An inkjet head 102M is an inkjet head 102 for M color. An inkjet head 102C is an inkjet head 102 for C color. An inkjet head 102K is an inkjet head 102 for K color. An inkjet head 102R is an inkjet head 102 for R color. An inkjet head 102G is an inkjet head 102 for G color. An inkjet head 102B is an inkjet head 102 for B color. These inkjet heads 102, for example, can be considered as inkjet heads 102 configured to eject dark ink, which is ink having a standard color density. As described above, in the present example, the head 12 has inkjet heads having different color densities for K color and RGB colors. In this case, the inkjet head 102K, the inkjet head 102R, the inkjet head 102G, and the inkjet head 102R can be considered as an example of dark ink heads, which are inkjet heads configured to eject ink of relatively dark colors corresponding to the respective colors.

An inkjet head 102Lk, an inkjet head 102Lr, an inkjet head 102Lg, and an inkjet head 102Lk are inkjet heads 102 configured to eject light ink (light-shade ink, low-density ink), which are ink of colors lighter than the dark ink of the same colors. The inkjet head 102Lk, the inkjet head 102Lr, the inkjet head 102Lg, and the inkjet head 102Lk can be considered as an example of light ink heads, which are inkjet heads configured to eject ink of relatively light colors corresponding to the respective colors. More specifically, in this case, the inkjet head 102Lk is an inkjet head 102 for light ink of K color. The inkjet head 102Lr is an inkjet head 102 for light ink of R color. The inkjet head 102Lg is an inkjet head 102 for light ink of G color. The inkjet head 102Lb is an inkjet head 102 for light ink of B color.

In regard to the relation between dark ink and light ink, the same color means substantially the same color. Substantially the same color means that, for example, colors are in a range that can be treated as the same color in accordance with quality required for printing. The range that can be treated as the same color is, for example, a range that can be treated as the same color in processing of color separation during printing. In regard to dark ink, a relatively dark color means a color darker than light ink of the same color. In regard to light ink, a relatively light color means a color lighter than dark ink of the same color. In the present example, the printing apparatus 10 uses ink of a plurality of colors to represent various colors by subtractive color mixing. In this case, for example, the colors of YMC are an example of primary colors, which are basic colors in the subtractive color mixing. The primary colors, for example, can be considered as basic colors with which colors can be represented by subtractive color mixing in principle. The inkjet head 102Y, the inkjet head 102M, and the inkjet head 102C are an example of inkjet heads 102 for primary colors. In this case, for example, the inkjet head 102Y, the inkjet head 102M, and the inkjet head 102C can be considered as inkjet heads configured to eject ink of different primary colors. In the present example, light ink is not used but dark ink is used as ink of primary colors. Thus, the configuration in the present example can be considered as a configuration in which only one kind of inkjet heads 102 for density ink are used as inkjet heads 102 for the respective primary colors.

In the present example, the RGB colors are an example of secondary colors that are colors obtained by mixing of a plurality of primary colors in principle. In this case, colors obtained by mixing in principle are, for example, colors obtained by mixing in a color space in principle. The secondary colors can be considered as colors obtained by mixing two kinds of primary colors. More specifically, in the present example, the RGB colors are intermediate colors of two kinds of primary colors. Ink of the RGB colors, for example, is adjusted to the corresponding color by using a colorant (such as pigment) for each of the RGB colors rather than actually mixing ink for primary colors. In the present example, the inkjet head 102R, the inkjet head 102G, the inkjet head 102B, the inkjet head 102Lr, the inkjet head 102Lg, and the inkjet head 102Lb are an example of inkjet heads 102 for secondary colors. Of the colors of ink used in the present example, K color can be considered as tertiary color. The inkjet head 102K and the inkjet head 102Lk are an example of black color heads. According to the present example, for example, printing is performed by seven-color separation using ink of seven colors including primary colors, secondary colors, and tertiary colors, and hence colorful printing can be appropriately performed. The seven-color separation is, for example, a method of printing by using ink of seven or more colors.

In the present example, by further using light ink in addition to dark ink for each of the colors of K and RGB, granularity can be appropriately prevented from being conspicuous. More specifically, subtractive color mixing represents various colors by absorbing light in a partial wavelength range at dots of ink of the colors formed on the medium 50. In this case, the wavelength range where ink of secondary colors absorbs light can be considered as a range obtained by combining wavelength ranges where primary colors to be mixed absorb light. As a result, an amount of light reflected in dots of ink of secondary colors becomes smaller than an amount of light reflected in dots of ink of primary colors. Similarly, an amount of light reflected in dots of black ink, which is a tertiary color, becomes even smaller than the amounts of light reflected in dots of ink of primary colors and secondary colors. In this case, because a smaller amount of light is reflected, dots of ink of the secondary colors and the tertiary color look darker because the brightness is lower than that of dots of ink of the primary colors. When printing is performed by seven-color separation, dots of ink of one secondary color are formed instead of dots of ink of a plurality of primary colors, and hence the density of the dots may decrease. As a result, individual dots of ink may be easily conspicuous. Due to these reasons, the granularity may be easily conspicuous if ink of secondary colors or tertiary colors is simply used in printing by seven-color separation. In the present example, on the other hand, light ink is used for each of secondary colors and tertiary colors, and hence the granularity can be appropriately prevented from being conspicuous.

To more reliably prevent the granularity from being conspicuous by using light ink, it is preferred to use dark ink and light ink for ink of every color used for printing. In this case, it is conceivable to use light ink for not only secondary colors and tertiary colors but also primary colors. In this case, however, the number of inkjet heads 102 included in the head 12 may be too large and the head 12 may be upsized excessively. The increase in number of inkjet heads 102 and the upsizing of the head 12 may greatly increase the cost of the device. On the other hand, as described above, the granularity in print results may be more conspicuous by using secondary colors or tertiary colors. Thus, in the present example, light ink and dark ink are not used for primary colors, but only ink (dark ink) having one kind of density is used, and dark ink and light ink are used for only secondary colors and tertiary colors. Thus, according to the present example, for example, the number of inkjet heads can be prevented from being too large, and the excessive upsizing and cost increase of the head 12 can be suppressed. Consequently, for example, the granularity can be more appropriately prevented from being conspicuous when printing is performed by seven-color separation. In this case, in particular, dots of ink of the K color are more likely to cause granularity to be conspicuous than those of ink of other colors. On the other hand, in the present example, light ink is used for K color, and hence the granularity can be more appropriately prevented from being conspicuous in print results.

When light ink is used, the amount of ink necessary for representing the same density may become larger than that when only dark ink is used. Thus, when light ink is simply used, the total amount of ink ejected to a unit area on a medium 50 per unit time may increase. As a result, the total amount of ink may be excessive, and ink bleeding may easily occur. More specifically, in this case, because ink may easily bleed, for example, high-quality printing may be difficult to perform if a medium having no image receiving layer formed thereon is used. As a result, for example, a medium 50 such as paper, close, and a plastic film may be difficult to use. In regard to this point, for example, if solvent ink is used, when a vinyl chloride film in which no image receiving layer is formed (coated) is used as a medium, printing may be possible by heating the medium by a print heater. In this case, however, printing can be performed only with a vinyl chloride film having characteristics that a contact angle of ink with a solvent is large, and the available medium 50 is extremely limited. Thus, for example, when a medium 50 such as polyester or propylene is used, the problem of bleeding is severe and, in general, high-quality printing is difficult to perform. Even when a vinyl chloride film is used, the problem of bleeding may be severe if the total amount of ink ejected to a unit area on the medium 50 per unit time increases. Other than the problem of bleeding, the medium 50 may swell to cause problems of curling and cockling depending on the kinds of ink and the medium 50 in use. More specifically, for example, if a medium 50 such as paper or fabric is used when ink in which the main component of its solvent is water is used, the medium 50 swells to easily cause the problem of curling and cockling.

On the other hand, in the present example, as illustrated in FIG. 1B, the inkjet heads 102 in the head 12 are arranged separately in head rows 202a and 202b, and a maximum value of the total amount of ink is appropriately reduced. Consequently, the occurrence of the problem of ink bleeding can be appropriately prevented. More specifically, in this case, the head rows 202a and 202b are rows in which one or more inkjet heads 102 are arranged in the main scanning direction. In the present example, the inkjet heads 102 in the head 12 are arranged such that two head rows 202a and 202b in which positions in the sub scanning direction are shifted. Accordingly, the inkjet head 102 in each head row is arranged such that the position in the sub scanning direction does not overlap with that of inkjet heads 102 in other head rows. More specifically, in the head 12 in the present example, inkjet heads 102 for ink other than light ink of secondary colors are arranged side by side in one head row 202a. Inkjet heads 102 for light ink of secondary colors are arranged side by side in one head row 202b different from the head row 202a. Accordingly, in the present example, for each of the RGB colors as secondary colors, an inkjet head 102 for dark ink (inkjet head 102R, inkjet head 102G, or inkjet head 102b) and an inkjet head 102 for light ink (inkjet head 102Lr, inkjet head 102Lg, or inkjet head 102b) are arranged in different head rows.

As described above, in the case where light ink is used, if light ink is simply used, the total amount of ink ejected to a unit area on the medium 50 per unit time may be excessive and the problem of ink bleeding may easily occur. On the other hand, in the present example, for each of the RGB colors as secondary colors, an inkjet head 102 for dark ink and an inkjet head 102 for light ink of the same color are arranged in different head rows, and hence the inkjet heads 102 for light ink and the inkjet heads 102 for dark ink are arranged such that positions in the sub scanning direction are shifted so as not to overlap with one another. Consequently, for example, a region where the inkjet head 102 for light ink ejects ink and a region where the inkjet head 102 for dark ink ejects ink are controlled to be different during each main scanning operation. In this case, as described in detail later, the amount of ink ejected to each position on the medium 50 in one main scanning operation can be appropriately reduced. Thus, according to the present example, for example, even when light ink is used, the total amount of ink ejected to a unit area on the medium 50 per unit time can be appropriately prevented from being excessive. Consequently, for example, the occurrence of the problem of ink bleeding can be appropriately prevented. Furthermore, in this case, ink bleeding occurs less frequently, and hence, for example, high-speed printing can be performed more appropriately. Consequently, according to the present example, for example, colorful and high-speed printing can be performed more appropriately.

In the present example, in regard to the inkjet heads 102 for color K, which is a tertiary color, the inkjet head 102K for dark ink and the inkjet head 102Lk for light ink are arranged in the same head row 202a. The reason is that dark ink and light ink of K color are less frequently ejected to the same position on the medium 50 in general. Thus, even when the inkjet head 102K and the inkjet head 102Lk are arranged in the same head row, the total amount of ink ejected to a unit area on the medium 50 per unit time is less likely to be excessive. In modifications of the configuration of the head 12, the inkjet head 102Lk may be arranged in a head row different from that of the inkjet head 102K.

As described above, in the present example, the inkjet heads 102 for ink other than light ink of secondary colors are arranged side by side in one head row 202a. For example, this configuration can be considered as a configuration in which the inkjet heads 102 for primary colors and the inkjet heads 102 for secondary colors are arranged in the same head row 202a. With such a configuration, for example, even when a large number of inkjet heads 102 are used in seven-color separation, the inkjet heads 102 can be arranged in a compact and appropriate manner. Such a configuration can be considered, for example, as a configuration in which the inkjet heads 102 for primary colors are arranged in the same head row as that of any of the inkjet heads 102 for secondary colors. In this case, this configuration can be considered as a configuration in which the inkjet head 102 for at least one of primary colors is arranged in the same head row as that of the inkjet heads 102 for dark ink of the RGB colors. In this case, as in the present example, it is preferred that the inkjet heads 102 for all primary colors be arranged in the same head row as that of the inkjet heads 102 for dark ink of the RGB colors. With such a configuration, for example, even when a large number of inkjet heads are used, the inkjet heads can be arranged in a more compact manner. In modifications of the configuration of the head 12, for example, the inkjet head 102 for at least one of primary colors may be arranged in the same head row as that of the inkjet heads 102 for light ink of the RGB colors. Also in this case, it is preferred that the inkjet heads 102 for all primary colors be arranged in the same head row as that of the inkjet heads 102 for light ink of the RGB colors.

The arrangement of the inkjet heads 102 in the head 12 is not limited to the configuration illustrated in FIG. 1B, and can be variously modified. In this case, the preferred arrangements of the inkjet heads 102 can be discussed, for example, in relation to the amount of ink ejected onto a medium 50. More specifically, for example, when a total amount of ink ejected to positions on a medium 50 during one main scanning operation is defined as a main scanning ink amount, and the main scanning ink amount ejected once to every ejection position of ink, the positions being set in accordance with a printing resolution, is defined as a main scanning ink amount of 100%, for example, the inkjet heads 102 may be arranged so as to form a plurality of head rows to reduce the maximum main scanning ink amount. In this case, it is preferred to arrange the inkjet heads 102 such that the maximum main scanning ink amount becomes 100% or less. With such a configuration, for example, the total amount of ink ejected to a unit area on the medium 50 per unit time can be appropriately prevented from being excessive.

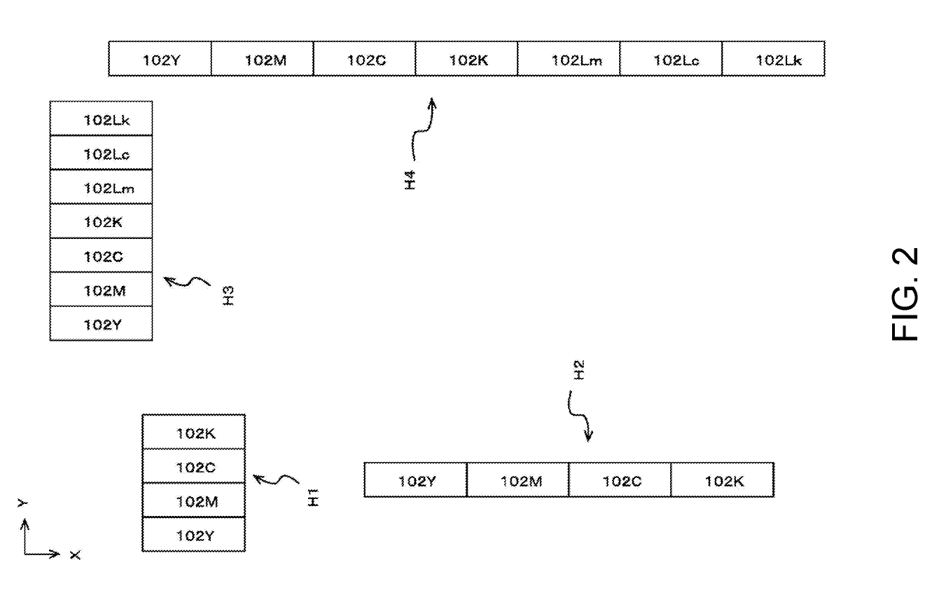

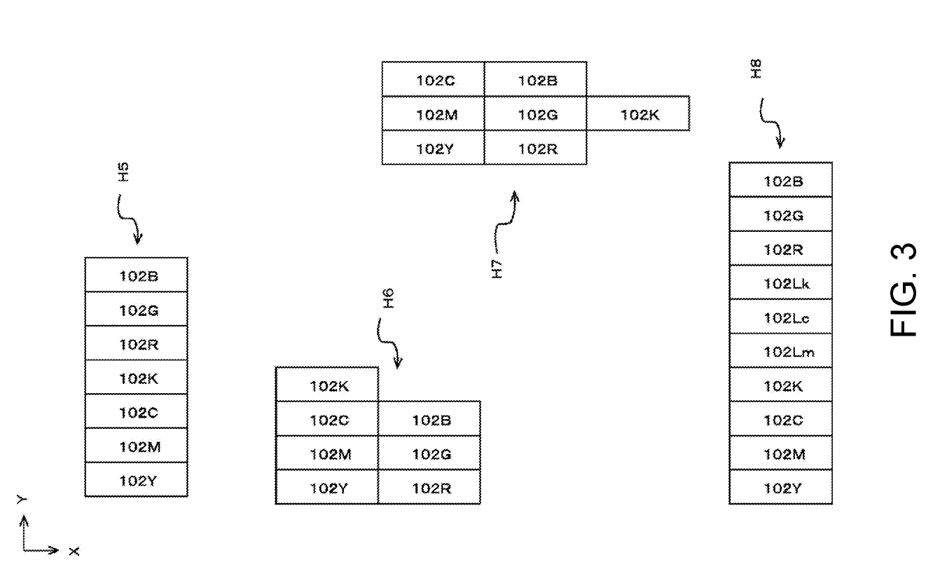

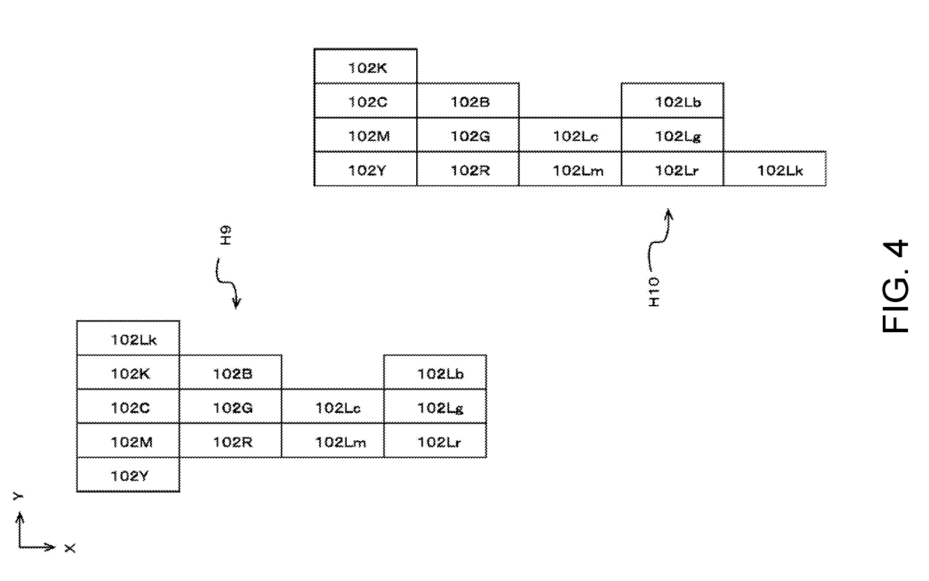

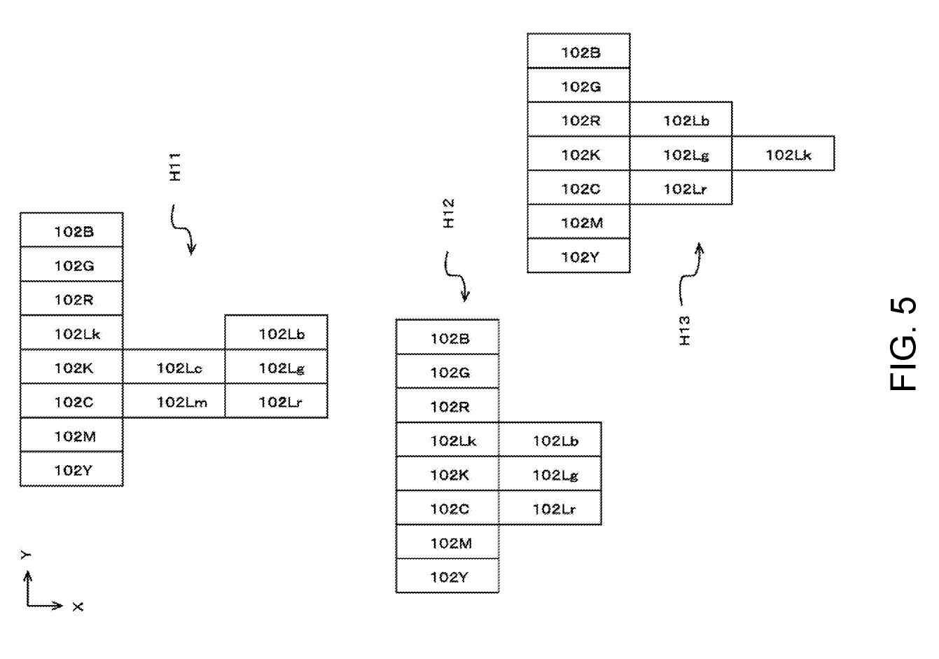

Subsequently, modifications of the configuration of the head 12 are described. First, for the sake of description, various examples of the configuration of the head 12 including the head 12 having the configuration illustrated in FIG. 1B and configurations other than preferred modifications (for example, conventional configurations) are illustrated. FIGS. 2 to 5 illustrate various examples of the configuration of the head 12. Of those, FIG. 2 and FIG. 3 are examples of the configuration of the head 12 when light ink of secondary colors is not used. FIG. 4 and FIG. 5 are examples of the configuration of the head 12 when light ink of secondary colors is used. In this case, the configurations illustrated in FIG. 4 and FIG. 5 can be considered as preferred examples of the configuration of the head 12. As described in detail later, when focusing on the total amount of ink ejected to a unit area on a medium per unit time and a number of head rows in the head 12, each configuration illustrated in FIG. 5 can be considered as a configuration capable of appropriately reducing the total amount of ink while suppressing the number of head rows. Thus, the configurations illustrated in FIG. 5 can be considered as a particularly preferred example of the configuration of the head 12. For the sake of illustration, FIGS. 2 to 5 omit the carriage 100 (see FIGS. 1) and schematically illustrate the arrangement of inkjet heads 102 of respective colors included in the head 12. Except for points described below, the heads 12 having the configurations illustrated in FIGS. 2 to 5 may have the same or similar features as those of the head 12 illustrated in FIG. 1B.

FIG. 2 illustrates an example of the configuration of four kinds of heads 12 denoted by symbols H1 to H4 in FIG. 2 in the case where ink of four colors of YMCK is used. For example, the configurations of the head 12 illustrated in FIG. 2 can be considered as examples of the configuration for four-color separation. More specifically, the configuration denoted by symbol H1 is a configuration in which inkjet heads 102 for colors of YMCK are arranged in one row in the main scanning direction. This configuration can be considered as, for example, a configuration corresponding to a conventional commonly-used configuration (conventional head arrangement). The configuration denoted by symbol H2 is a configuration in which inkjet heads 102 for colors of YMCK are arranged such that positions in the sub scanning direction are shifted. When the head 12 having such a configuration is used, ink is ejected to each position on a medium in different main scanning operations. Thus, this configuration can be considered as, for example, a color sequential configuration in which ink of colors is sequentially ejected to each position on a medium.

The configurations denoted by symbols H3 and H4 are configurations obtained by adding inkjet heads 102 for light ink of the M color, the C color, and the K color to the configurations denoted by symbols H1 and H2, respectively. These configurations can be considered as examples of a configuration of four-color separation added with inkjet heads 102 for light ink (four-color separation with light color), for example. In the figures, the inkjet head 102Lm is an inkjet head 102 for light ink of the M color. The inkjet head 102Lc is an inkjet head 102 for light ink of the C color. The configuration denoted by symbol H3 is a configuration in which all inkjet heads 102 are arranged side by side in the main scanning direction. This configuration can be considered as a configuration in which all inkjet heads 102 are arranged in one head row, for example. The configuration denoted by symbol H4 is a configuration in which all inkjet heads 102 are arranged such that positions in the sub scanning direction are shifted. This configuration can be considered as, for example, a configuration (complete color sequential arrangement) in which all inkjet heads 102 are arranged in mutually different head rows.

FIG. 3 illustrates examples of the configuration of four kinds of heads 12 denoted by symbols H5 to H8 in FIG. 3 in the case where ink of seven colors of YMCKRGB is used. The configurations of the heads 12 illustrated in FIG. 3 can be considered as examples of the seven-color separation configuration, for example. Each configuration illustrated in FIG. 3 can be considered as an example of the seven-color separation configuration in the case where light ink is not used for secondary color, for example. More specifically, the configuration denoted by symbol H5 is a configuration in which inkjet heads 102 for dark ink of colors of YMCKRGB are arranged in the main scanning direction in a row. The configuration denoted by symbol H6 is a configuration in which inkjet heads 102 for dark ink of colors of YMCK are arranged in one head row and inkjet heads 102 for dark ink of colors of RGB are arranged in another head row. The configuration denoted by symbol H7 is a configuration in which inkjet heads 102 for dark ink of colors of YMC are arranged in one head row, inkjet heads 102 for dark ink of colors of RGB are arranged in another head row, and an inkjet head 102 for dark ink of K color is arranged in still another head row. The configuration denoted by symbol H8 is a configuration which is obtained by further adding inkjet heads 102 for light ink of M color, C color, and K color to the configuration denoted by symbol H5 and in which all inkjet heads 102 are arranged in one head row. This configuration can be considered, for example, as an example of a the seven-color separation configuration (seven-color separation with light color) added with inkjet heads 102 for light ink. This configuration can be considered, for example, as a configuration obtained by adding inkjet heads 102 for light ink to the conventional head arrangement.

FIG. 4 illustrates an example of the configuration of two kinds of heads 12 denoted by symbols H9 and H10 in FIG. 4 in the case where ink of seven colors of YMCKRGB is used. The configurations of the heads 12 illustrated in FIG. 4 can be considered as examples of the seven-color separation configuration added with inkjet heads 102 for light ink (seven-color separation with light color). More specifically, in the configurations of the heads 12 illustrated in FIG. 4, inkjet heads 102 for light ink are used for all colors other than Y color. The configuration denoted by symbol H9 is a configuration in which inkjet heads 102 for dark ink of YMCK colors and an inkjet head 102 for light ink of K color are arranged in one head row, inkjet heads 102 for dark ink of RGB colors are arranged in another head row, inkjet heads 102 for light ink of M color and C color are arranged in still another head row, and inkjet heads 102 for light ink of RGB colors are arranged in still another head row. The configuration denoted by symbol H10 is a configuration in which inkjet heads 102 for dark ink of YMCK colors are arranged in one head row, inkjet heads 102 for dark ink of RGB colors are arranged in another head row, inkjet heads 102 for light ink of M color and C color are arranged in still another head row, inkjet heads 102 for light ink of RGB colors are arranged in still another head row, and an inkjet head 102 for light ink of K color is arranged in still another head row.

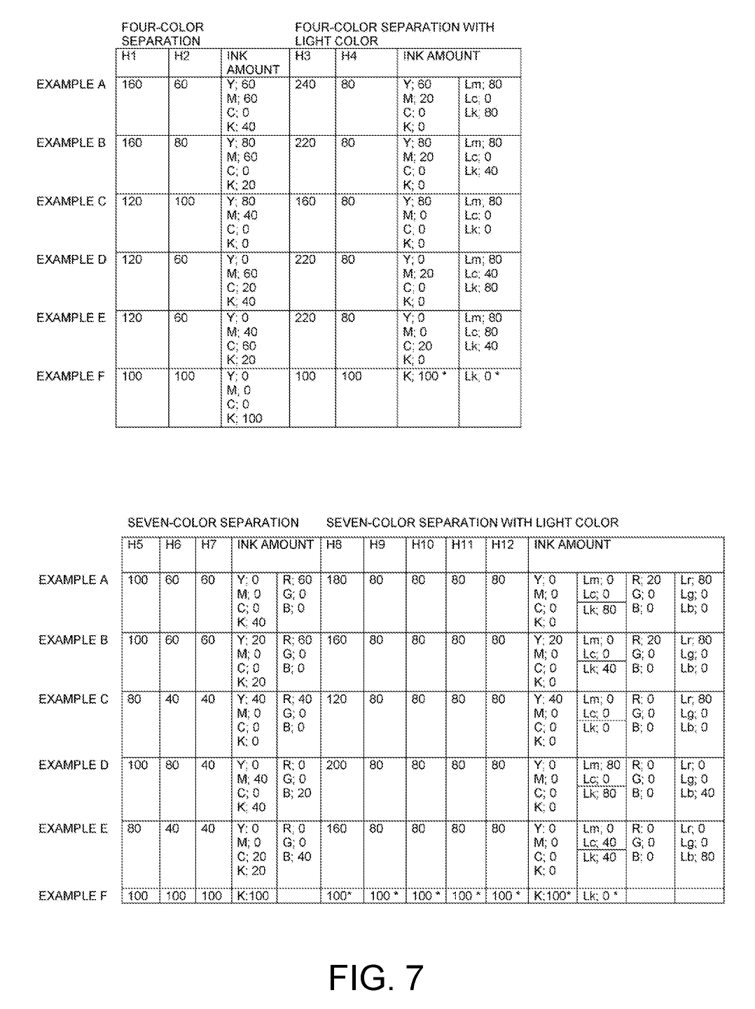

FIG. 5 illustrates an example of the configuration of three kinds of heads 12 denoted by symbols H11 to H13 in FIG. 5 in the case where ink of seven colors of YMCKRGB is used. The configurations of the heads 12 illustrated in FIG. 7 can be considered as examples of the seven-color separation configuration added with inkjet heads 102 for light ink (seven-color separation with light color), for example. Of the configurations of the heads 12 illustrated in FIG. 5, in the configuration denoted by symbol H11, inkjet heads 102 for light ink are used for all colors other than Y color. More specifically, this configuration is a configuration in which inkjet heads 102 for dark ink of YMCKRGB colors and an inkjet head 102 for light ink of K color are arranged in one head row, inkjet heads 102 for light ink of M color and C color are arranged in another head row, and an inkjet head 102 for light ink of RGB colors is arranged in still another head row.

In the configurations denoted by symbols H12 and H13, inkjet heads 102 for light ink of primary colors are not used, but inkjet heads 102 for light ink are used for only secondary colors and tertiary colors. More specifically, the configuration denoted by symbol H12 is a configuration in which inkjet heads 102 for dark ink of YMCKRGB colors and an inkjet head 102 for light ink of K color are arranged in one head row, and inkjet heads 102 for light ink of RGB colors are arranged in another head row. This configuration can be considered, for example, as a configuration in which inkjet heads 102 for dark ink of YMCRGB and K colors and an inkjet head 102 for light ink of K color (Lk) are arranged on the same Y axis side by side in the main scanning direction, and inkjet heads 102 for light ink of RGB colors (Lr, Lg, and Lb) are arranged on the same Y axis side by side in the main scanning direction at positions shifted in parallel with the sub scanning direction. The configuration denoted by symbol H13 is a configuration in which inkjet heads 102 for dark ink of YMCKRGB colors are arranged in one head row, inkjet heads 102 for light ink of RGB colors are arranged in another head row, and an inkjet head 102 for light ink of K color is arranged in still another head row. As is understood from the matters described below, when focusing on the total amount of ink ejected to a unit area on a medium per unit time and the number of head rows in the head 12, for example, the head arrangements of H11 to H13 can be considered as configurations capable of appropriately reducing the total amount of ink while suppressing the number of head rows. Of these, in particular, the head arrangements of H12 and H13 can be considered as configurations capable of performing high-quality and high-speed printing with a smaller number of inkjet heads 102.

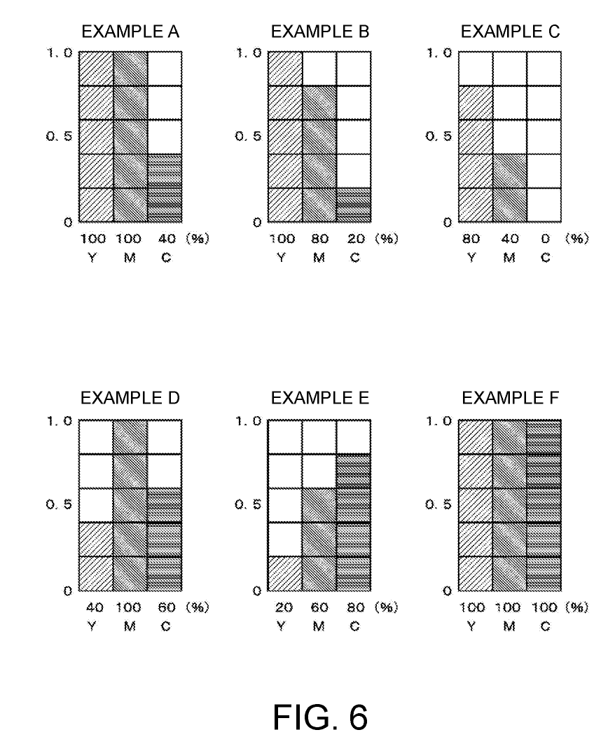

Subsequently, examples of the total amount of ink ejected to a unit area on a medium per unit time in each of the configurations of the heads 12 illustrated in FIGS. 2 to 5 are described. FIG. 6 is a diagram for describing examples of colors represented by mixing of ink of a plurality of colors, and illustrates an amount of ink of each color (ratio of amount of ink of each color) in a case where six kinds of colors denoted by Examples A to F in FIG. 6 are represented by using only ink of three colors of YMC. Examples A to F illustrated in FIG. 6 can be considered as examples (sample data) of combinations of ink amounts of YMC colors, which are three basic primary colors in subtractive color mixing.

Representation of colors by subtractive color mixing enables full-color representation by using only three YMC colors as primary colors in principle. In this case, for example, as in Examples A to F in FIG. 6, various colors can be expressed by mixing ink of the colors with different ratios. In actual ink, however, due to a wavelength range where a colorant (such as pigment) for giving color to ink, colorful representation may be difficult for colors other than YMC (intermediate colors). On the other hand, when printing is performed by seven-color separation, the use of ink of the RGB colors as secondary colors or ink of the K color as a tertiary color enables intermediate colors or the K color to be colorfully represented. In this case, by using ink of a secondary color or a tertiary color instead of mixing ink of a plurality of primary colors, the total amount of ink ejected to a unit area on a medium per unit time can be reduced. More specifically, when printing is performed by seven-color separation, colors can be converted by the following relational equations such that ink of the RGB colors or ink of the K color is used instead of ink of the YMC colors:

αR=αY+αM Equation (1);

βG=βC+βY Equation (2);

γB=γM+γY Equation (3); and

δK=δY+δM+δC Equation (4).

Of these equations, Equation (1) indicates that equal amounts of ink of the Y color and the M color as two primary colors are replaced with an equal amount of ink of the R color as a secondary color. Equations (2) and (3) indicate that ink of two primary colors is replaced for the G color and the B color, respectively. Through such conversion, the amount of ink for expressing the same color after conversion becomes a half of the total (total amount) of ink of primary colors before conversion. Equation (4) indicates that equal amounts of ink of the Y color, the M color, and the C color as three primary colors are replaced with an equal amount of ink of the K color as a tertiary color. Through such conversion, the amount of ink for expressing the same color after conversion becomes ⅓ of the total (total amount) of ink of primary colors before conversion.

As is understood from such conversion equations, in the case where printing is performed by seven-color separation, the total amount of ink ejected to a unit area on a medium per unit time can be reduced as compared with the case where printing is performed by only primary colors and the case where printing is performed by four-color separation. In this case, however, because the amount of ink is reduced, a density of dots of ink (landed dot density) formed on the medium is also reduced, and the granularity of images becomes more conspicuous. As described above, dots of ink of secondary colors look darker than dots of ink of primary colors, and hence when printing is performed by seven-color separation, the granularity is more conspicuous in this viewpoint. As a result, a half-tone part of the image may look coarse, and the image quality of print results may decrease. To prevent the granularity of images from being conspicuous, as described above, light ink may be used for the RGB colors and the K color and, if necessary, the M color and the C color. For example, the use of light ink can improve the gradation reproducibility for halftones and reduce the granularity of printed images. Consequently, for example, the printed image quality can be improved. In this case, light ink having a density of N/2, which is a half of a density N of dark ink, corresponding to the conditions indicated by the above-mentioned equations may be used.

As described above, however, when light ink is used, the total amount of ink ejected to a unit area on a medium per unit time may increase. In regard to this point, the total amount of ink ejected to a unit area on the medium 50 per unit time can vary depending on the number of colors of ink in use, whether light ink is used, and the arrangement of the inkjet heads 102, for example. Thus, when light ink is added to perform printing by seven-color separation, it is desired to arrange the inkjet heads 102 such that the total amount of ink ejected to a unit area on the medium per unit time is not excessive. Now, examples of the total amount of ink ejected to a unit area on a medium per unit time are described by associating each of the configurations of the heads 12 described above with reference to FIGS. 2 to 5 with colors denoted by Examples A to F in FIG. 6.

FIG. 7 is a diagram for describing a total amount of ink ejected to a unit area on a medium per unit time. For the sake of description, FIG. 7 illustrates a total amount of ink ejected to a unit area on a medium per unit time in the configurations described above with symbols H1 to H12 among the configurations (various kinds of head arrangements) of the heads 12 described above with reference to FIGS. 2 to 5. In this case, the total amount of ink ejected to the unit area on the medium per unit time is an average of the amounts of ink (average ink amount) ejected to positions on a medium in one main scanning operation (pass) in the case where colors corresponding to Examples A to F are represented. The average is an average amount of ink in the range of a matrix of 16×16 pixels. In this case, the contents of the table illustrated in FIG. 7 can be considered as, for example, a table indicating the relation between the head arrangement (head array) and the maximum ink amount per pass. This table can also be considered as, for example, a table indicating the relation between the head arrangement and the amount of ink landed per unit area.

Regarding the amount of ink, a density is 100% when ink of one color is ejected once at positions (dot positions) of all pixels. Regarding dark ink and light ink of the same color, a density Ln of colors of light ink is ½ of a density N of colors of dark ink, that is, Ln=(N/2). How dark ink and light ink are used is set to be exclusive such that dark ink and light ink of the same color are not ejected to the same pixel position. For colors obtained by mixing 100% of three colors of YMC each (parts denoted by * in the table) as in Example F, light ink is not used but only dark ink is used. More specifically, for 100% of the K color in the table, printing is performed by using no light ink (Lk) and only 100% of dark ink (K) to reduce the ink amount. Also for other colors (such as RGB colors), printing is performed by using only dark ink for the ink amount of 100% to reduce the ink amount.

Regarding the configurations of the heads 12, in the case of the configuration of the head 12 denoted by symbol H1 in FIG. 2 (hereinafter referred to as “head arrangement of H1”; similarly, the configurations of the heads 12 denoted by symbols H2 and so on in FIGS. 2 to 5 are referred to as “head arrangement of H2” and so on), printing is performed by four-color separation, and the total amount of ink ejected to a unit area per unit time is separated into four of the YMCK colors to be values indicated in the table. In this case, the total amount of ink ejected to a unit area per unit time is a total amount of ink landed on a unit area per unit time. More specifically, the ink amount indicated in the table is a maximum landed ink amount that is the amount of ink corresponding to the maximum main scanning ink amount. For example, the maximum landed ink amount can be considered as the maximum amount of ink (total ink amount) landed per unit area. In this case, the maximum landed ink amount is 160% in the result corresponding to Examples A. In all the results corresponding to the other examples than Example F where 100% of printing is performed by only the K color, the maximum landed ink amounts exceed 100%. In this case, the amounts of ink landed near one another on the medium 50 increase, and hence the bleeding is more likely to occur and high-speed printing is difficult to perform.

On the other hand, when printing is performed by the color sequential system as represented by the head arrangement of H2, the maximum landed ink amount can be reduced as indicated in the table. As described in detail later, however, if the configuration of the color sequential system is employed for seven-color separation or seven-color separation using light ink, the width of the head 12 in the sub scanning direction becomes too large. In the case where light ink of the M color, the C color, and the K color is used as represented by the head arrangements of H3 and H4, the granularity can be reduced, for example, as compared with the case where the head arrangements of H1 and H2 are used. In these cases, however, colorful printing is difficult to perform, for example, as compared with the case where printing is performed by seven-color separation. In addition, when the head arrangement of H3 is used, the maximum landed ink amount significantly increases as indicated in the table. When the head arrangement of H4 is used, there is a problem in that the width of the head in the sub scanning direction further increases.

In the case where printing is performed by inkjet, it is considered that bleeding occurs particularly easily when the maximum landed ink amount exceeds 100%. More specifically, in a serial inkjet printer configured to control an inkjet head to perform a main scanning operation, printing is generally performed by a multi-pass method with about 16 passes (for example, about 8 to 32 passes). In this case, by increasing the number of passes, the amount of ink ejected to the same position during one main scanning operation can be reduced. In this case, for example, if a medium having an image receiving layer for ink is used, the occurrence of bleeding can be suppressed even when the maximum landed ink amount is large. However, if a medium having no image receiving layer formed thereon (for example, paper, fabric, or polyester film) is used, for example, bleeding easily occurs when the maximum landed ink amount exceeds 100% even by printing at normal printing speed. As a result, for example, high-speed printing is difficult to perform. In the case where the maximum landed ink amount exceeds 100%, bleeding easily occurs in high-speed printing even when a medium having an image receiving layer is used. In regard to this point, in the head arrangement of H1, the maximum landed ink amount reaches 160% in the results using only four colors of dark ink. In the head arrangement of H3 using light ink, the maximum landed ink amount reaches 240%. Thus, in the case where these head arrangements are used, when a medium having no image receiving layer formed thereon is used or high-speed printing is performed, the problem of bleeding is more severe, and it is difficult to appropriately perform high-quality printing.

To suppress the occurrence of bleeding, for example, it is conceivable to use a method of using a heater configured to dry ink at a high temperature or a method of using a coagulant for aggregating ink. In this case, however, the configuration of a medium or ink that can be used is limited. As a result, for example, printing may be difficult to perform with a configuration (high-speed machine) configured to print on a medium having no image receiving layer formed thereon serially and directly at high speed. As described above, when the head arrangements of H2 and H4 are used, the maximum landed ink amount can be suppressed. These cases, however, cause a problem in that the width of the head 12 in the sub scanning direction increases as described above. As a result, the problem of upsizing of the printing apparatus arises. In particular, such a problem is considered to be conspicuous in the case of the head arrangement of H4.

On the other hand, for example, when the head arrangements of H5 to H12 are used, colorful printing can be more appropriately performed by using seven-color separation. The maximum landed ink amount can be reduced by using ink of secondary colors instead of ink of primary colors. Consequently, for example, even when the printing speed is increased, the occurrence of bleeding can be suppressed more appropriately. More specifically, for example, even when all inkjet heads are arranged in one head row as represented by the head arrangement of H5, the maximum landed ink amount is 100% or less in all Examples A to F. In this case, the bleeding less occurs because the maximum landed ink amount is small. As a result, even when a medium that easily causes bleeding, such as a polyester film, printing can be appropriately performed by suppressing the bleeding. In this case, because the bleeding is less likely to occur, high-speed printing can be performed more appropriately. In the case where printing is performed by seven-color separation, for example, when inkjet heads are arranged separately in head rows as represented by the head arrangements of H6 and H7, the maximum landed ink amount can be further reduced as illustrated in the table.

However, when printing is performed by simple seven-color separation simply using ink of seven colors as represented by the head arrangements of H5 to H7, as described above, dots of ink of secondary colors that look darker than those of primary colors are formed, and the appearance frequencies of secondary colors increase, and hence the granularity in images is more likely to be conspicuous. In this case, the granularity is more likely to be conspicuous also because primary colors are converted into secondary colors so that the number of dots (number of pixels) of ink formed on a medium are reduced. In the case of the head arrangements of H8 to H12, on the other hand, an inkjet head for light ink is used for at least one of colors. In this case, by using light ink, the granularity can be made less conspicuous in general. The gradation reproducibility can be improved as well.

In the case where light ink is used, however, the maximum landed ink amount may be excessive depending on the head arrangement even when printing is performed by seven-color separation. For example, when all inkjet heads are arranged in one head row as represented by the head arrangement of H8, the maximum landed ink amount greatly increases to 200% in Example D. As a result, the problem of bleeding becomes conspicuous, and when printing is performed at high speed (for example, printing in high-speed mode), it may be difficult to perform high-quality printing. This case corresponds to the configuration in which light ink for secondary colors is not used, and hence the granularity may be conspicuous due to dots of ink of secondary colors.

On the other hand, in the case of the head arrangements of H9 to H12, inkjet heads for light ink are used for secondary colors. More specifically, in these head arrangements, inkjet heads for light ink are used for at least the RGB colors, which are secondary colors, and the K color, which is a tertiary color. With such a configuration, for example, the appearance frequencies of dots of dark ink of the RGB colors and the K color are significantly reduced, and hence the granularity can be appropriately prevented from being conspicuous. In this case, printing is performed by seven-color separation, and hence the appearance frequencies of dots of dark ink of primary colors (for example, M color and C color) can be appropriately reduced. By using light ink, for example, colorful printing can be more appropriately performed with high gradation expression. In addition, in the head arrangements of H9 to H12, the inkjet heads are arranged such that an inkjet head for dark ink and an inkjet head for light ink of the same color are included in different head rows. In this case, inkjet heads are arranged side by side in at least a part of head rows, thereby preventing the number of head rows from being too large. As a result, in the case of the head arrangements of H9 to H12, as illustrated in the table, the maximum landed ink amounts are 100% or less in all Examples A to F. Thus, with these configurations, for example, printing can be more appropriately performed by seven-color separation (seven-color separation with light colors) in which inkjet heads for light ink are added for secondary colors while appropriately suppressing the bleeding.

In the case of the head arrangements of H9 to H12, the inkjet heads are arranged side by side separately in head rows, and hence the width of the head in the sub scanning direction increases as compared with the case where all inkjet heads are arranged side by side in one head row. However, when printing is performed by seven-color separation using ink for light colors, the number of necessary inkjet heads increases, and hence it is inevitable that a size of the head increases to some extent. In this case, the configuration in which the inkjet heads are arranged side by side separately in head rows can be considered reasonable. Also in this case, however, it is preferred that the number of head rows be not too large. More specifically, it is preferred that the number of head rows be five or less. The number of head rows is preferably four or less, more preferably three or less. In this case, the number of head rows is, for example, the number of head rows including inkjet heads in the printing apparatus. The inkjet heads in the printing apparatus are, for example, all inkjet heads used for printing in the printing apparatus.

As described above, in order to prevent the maximum landed ink amount from being excessive when printing is performed by seven-color separation using ink for light colors, it is preferred that an inkjet head for dark ink and an inkjet head for light ink of the same color be included in different head rows. Thus, it is preferred that the number of head rows be two or more. More specifically, in this case, for example, the head arrangement of H12 may be used. With such a configuration, for example, the maximum landed ink amount can be suppressed to be 100% or less while minimizing the number of head rows (two rows). Consequently, for example, when printing is performed by seven-color separation using ink for light colors, the printing speed can be increased more appropriately.

As described above with reference to FIG. 5 and others, in the head arrangement of H12, inkjet heads for light colors are not used for the M color and the C color, which are primary colors, but inkjet heads for light color are used for only secondary colors and tertiary colors, which more affect the granularity. Thus, this head arrangement can be considered to downsize the head by using inkjet heads for light color for only secondary colors and tertiary colors. Thus, the head arrangement of H12 can be considered as, for example, a configuration that is most suited to downsize the head, speed up printing, and improve printing quality (image quality). Although description is omitted in the table in FIG. 7, the head arrangement of H13 can be similarly considered to downsize the head. Also in this case, the maximum landed ink amount can be reduced to 100% or less similarly to the head arrangement of H12. Thus, for example, even such a configuration can appropriately arrange inkjet heads for secondary colors while preventing the number of head rows from being too large.

Description has been given above mainly of the maximum landed ink amounts corresponding to Examples A to F in the case where the density of colors of light ink is 1/2 (Ln=N/2) of dark ink. However, the granularity in print results becomes particularly conspicuous when the density (print density) of a printed color is low. Thus, the density of colors of light ink may be set to be lower than ½ of dark ink in order to suppress the granularity more reliably.

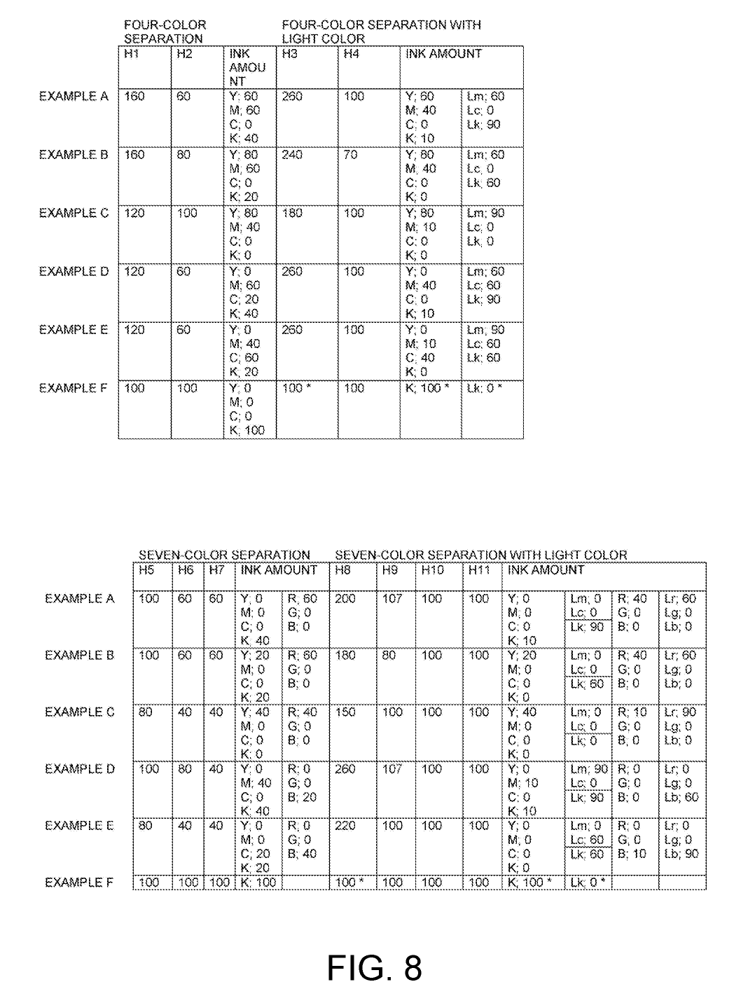

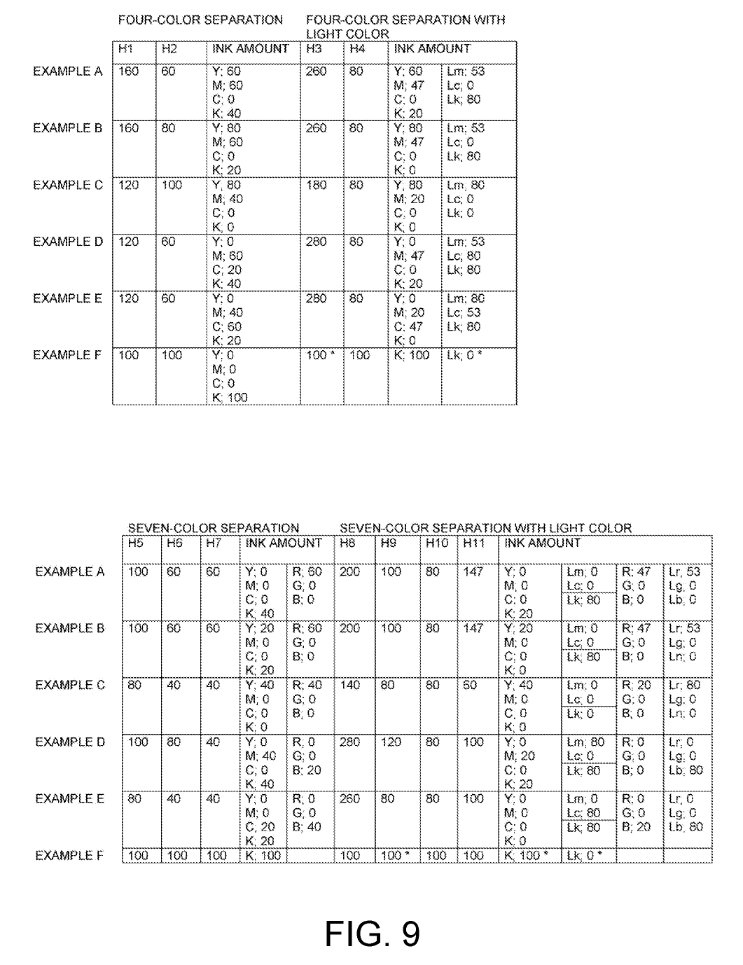

FIG. 8 and FIG. 9 are diagrams for describing maximum landed ink amounts when light ink having a lower color density is used, and illustrate the same matters as in FIG. 7 for the case where a color density of light ink is set to be lower than ½ of dark ink. More specifically, FIG. 8 illustrates the same matters as in FIG. 7 for the case where the color density Ln of light ink is ⅓ of the color density N of dark ink (case where Ln=N/3). FIG. 9 illustrates the same matters as in FIG. 7 for the case where the color density Ln of light ink is ¼ of the color density N of dark ink (case where Ln=N/4). As is understood from the tables in FIGS. 8 and 9, even when the color density of light ink is set lower, for example, in a configuration in which inkjet heads for light ink of secondary colors are used, the same effects as in the above can be obtained by using the head arrangement in which an inkjet head for dark ink and an inkjet head for light ink of the same color are included in different head rows.

For the sake of illustration and description, FIG. 8 and FIG. 9 include descriptions of the maximum landed ink amounts corresponding to Examples A to F for only the head arrangements of H1 to H11. As is clear from the above description, even when H12 and H13 are used, the maximum landed ink amounts can be appropriately prevented from being excessive while using the inkjet heads for light ink of secondary colors. In the results illustrated in FIG. 8 and FIG. 9, even when the inkjet heads are arranged in different head rows, such as H9 to H11, the maximum landed ink amounts exceed 100% in the results corresponding to a part of Examples A to F. In this case, however, by using the head arrangement in which an inkjet head for dark ink and an inkjet head for light ink of the same color are included in different head rows, the maximum landed ink amount can be significantly reduced, for example, as compared with the case where the head arrangement of H8 is used. Thus, when light ink of light colors whose color densities are less than ½ of dark ink is used, it is preferred to use the head arrangements of H9 to H13, though the maximum landed ink amounts corresponding to a part of the examples exceed 100%. In a more general sense, for example, it is preferred that the color density of light ink be selected from a range of about ⅕ to ½ of the color density of dark ink. With such a configuration, for example, colorful printing can be more appropriately performed with high gradation expression while preventing the granularity from being conspicuous.

Subsequently, supplemental description is given on each configuration described above. As described above, when printing is performed by seven-color separation, for example, colorful printing can be appropriately performed by using ink of RGB colors of secondary colors. In this case, by using light ink for secondary colors and the K color as a tertiary color, the gradation reproducibility for halftones can be improved, and the granularity of printed images can be reduced. Furthermore, in this case, an inkjet head 102 for dark ink and an inkjet head 102 for light ink of the same color are arranged in different head rows, and hence the maximum landed ink amount can be reduced, and the occurrence of bleeding can be appropriately suppressed.

In this case, as the specific configuration of the head, for example, it is preferred to use the head arrangements of H9 to H13 illustrated in FIG. 4 and FIG. 5. In view of downsizing the head, it is particularly preferred to use the head arrangements of H11 to H13. In this case, these head arrangements can be considered as, for example, head arrangements in which the occurrence of bleeding and the granularity can be suppressed to perform fine and colorful printing even when light ink is used to perform printing by seven-color separation, and the performance of the improvement of reproducibility for halftones, the colorful printing (high image quality), and high-speed printing can be simultaneously obtained. In this case, in view of the increase in speed, the downsizing of the head, and the achievement of high image quality, a preferred head arrangement may be selected from, for example, H9 to H13 depending on the main purpose. In this case, for example, the head arrangements of H11 to H13 can be considered as configurations in which the head arrangement are optimized by selecting the kind of light ink to be used.

In this case, because bleeding is less likely to occur, various kinds of media can be used. More specifically, as the medium, for example, various kinds of media such as fabric, paper, non-woven fabric, plastic films, ceramic, glass, pottery, and metal can be used. In this case, for example, even a medium having no image receiving layer formed thereon can be preferably used. The effects obtained by printing by seven-color separation can be considered as, for example, effects that the use amount of ink can be reduced to reduce a running cost of printing by using ink of secondary colors and tertiary colors.

The configuration in which bleeding is less likely to occur as described above can be considered to be particularly suited for applications where printing is performed by inkjet using ink or a medium that easily causes bleeding. In this case, more specifically, for example, this configuration can be preferably applied to a textile printer configured to print on fabric media and various kinds of industrial-use printers. The operation of printing by seven-color separation using light ink may be executed, for example, in response to designation of a mode by a user. In this case, for example, the printing apparatus may determine whether to use dark ink and light ink or switch color separation by software or hardware in response to instructions from a user.

In each of the above-mentioned configurations, ink to be used is not particularly limited, and various kinds of ink that can be ejected from inkjet heads can be used. More specifically, as ink, for example, aqueous dye ink using aqueous dye as a colorant or pigment ink using pigment as a colorant can be preferably used. Regarding the basic characteristics of ink and how to fix ink, for example, latex ink, solvent ink, UV curable ink, solvent diluted UV ink, or fast-drying ink may be used. In this case, the solvent diluted UV ink is, for example, UV curable ink (for example, solvent UV ink) diluted with a solvent (such as organic solvent).

As described above in relation to FIGS. 1, in the printing apparatus, an ink fixing device corresponding to characteristics of ink and media to be used may be used. More specifically, as the ink fixing device, for example, a heater may be used as described above with reference to FIGS. 1. As the heater, for example, a print heater configured to heat a medium at a position opposed to an inkjet head can be preferably used. As the ink fixing device, for example, a post-heating and drying configuration in which ink is dried on the downstream side of inkjet heads in the conveying of the medium or a configuration in which fast-drying ink such as UV fast-drying ink is irradiated with energy rays (ultraviolet rays) may be used. Other possible configurations include a configuration in which ink is dried by irradiation of infrared rays, a configuration in which ink is cured by irradiation of ultraviolet rays, and a configuration in which ink is cured by irradiation of electron beams. Depending on the characteristics of ink and media, various kinds of preprocessing (such as pre-drying) and postprocessing may be performed. As the medium, as described above, a medium on which an image receiving layer is not formed can be preferably used. The medium is not limited to such a medium, and, for example, a medium on which an image receiving layer is formed or a medium subjected to preprocessing for preventing bleeding (medium having preprocessing layer formed thereon) can be used.

Subsequently, other modifications of the configurations of the printing apparatus and the head are described. As described above, in order to perform colorful printing more appropriately by appropriately preventing the granularity from being conspicuous when light ink is used to perform printing by seven-color separation, it is preferred to use light ink for all secondary colors. To reduce the number of inkjet heads for use, however, for example, light ink may be used for only the RGB colors, which are secondary colors, and the K color, which is a tertiary color, as described above. Regarding this point, light ink may be used for only a part of secondary colors in order to further reduce the number of inkjet heads for use.

More specifically, apparent brightness of seven colors of ink used in seven-color separation is higher in Y color, M color, C color, G color, R color, B color, and K color in descending order of brightness. As a result, the granularity becomes more conspicuous in the reverse order. As a result, the granularity becomes particularly conspicuous for the K color, the B color, and the R color among the seven colors. Thus, when light ink is used for only a part of secondary colors, for example, an inkjet head for light ink may be used for the R color or the B color. In this case, for example, it is preferred that inkjet heads for light ink be used for both of the R color and the B color. It is preferred to use light ink for the K color as a tertiary color in addition to a part of the secondary colors. With such a configuration, the granularity can be appropriately prevented from being conspicuous by using a smaller number of inkjet heads.

Depending on required printing quality, a larger number of inkjet heads may be used. More specifically, examples of the head arrangement have been mainly described above for the case where there is only one kind of color density (light color density) of light ink. However, in order to perform higher-quality printing, for example, a plurality of kinds of ink having different color densities may be used as light ink having low brightness for the same color. In this case, the light color densities may be divided into two or more levels for the RGB colors as secondary colors and the K color as a tertiary color.

When printing is performed by seven-color separation, ink of color other than the seven colors of YMCKRGB may be further used. In this case, for example, ink of a particular color such as a metallic color or white may be further used. In this case, an inkjet head for a particular color may be arranged in a head row different from that of inkjet heads for ink of the above-mentioned seven colors. Depending on the frequency of use of the particular color or the probability that ink of the particular color is ejected to the same position as ink of other colors in the same main scanning operation (probability of simultaneous printing), the inkjet head for the particular color may be arranged side by side in the same head row as that of inkjet heads for primary colors, secondary colors, or tertiary colors.

To prevent the granularity from being conspicuous, a volume of ink ejected from an inkjet head may be made variable to form small-size dots of ink, in addition to the method using light ink. Thus, in each configuration described above, for example, an ejection volume variable head may be used for an inkjet head for at least a part of colors such that the volume of ink is made variable. In this case, the ejection volume variable head is, for example, an inkjet head (multi-value head, variable head) capable of setting at least two kinds of volumes as the volume of ejected ink. The ejection volume variable head can be considered, for example, as an inkjet head configured to eject ink with a plurality of kinds of volumes when printing images. More specifically, in this case, for example, an ejection volume variable head may be used as at least one of inkjet heads for primary colors. In this case, for example, an ejection volume variable head may be used as an inkjet head for a color for which light ink is not used. For example, when light ink is used for secondary colors and tertiary colors but not used for primary colors, ejection volume variable heads are not used for secondary colors and tertiary colors but may be used for only primary colors. With such a configuration, for example, the granularity can be prevented from being conspicuous more appropriately while preventing the number of inkjet heads from being too large. In another modification of the configuration of the printing apparatus, for example, ejection volume variable heads may be used as inkjet heads for all colors.

It will be apparent to those skilled in the art that various modifications and variations can be made to the disclosed embodiments without departing from the scope or spirit of the invention. In view of the foregoing, it is intended that the disclosure covers modifications and variations provided that they fall within the scope of the following claims and their equivalents.

What is claimed is:

1. A printing apparatus configured to print on a medium by inkjet, comprising:
a plurality of inkjet heads, configured to eject ink to the medium;
a main scanning driver, configured to control the inkjet heads to perform a main scanning operation of ejecting ink while moving relatively to the medium in a main scanning direction set in advance; and
a sub scanning driver, configured to control the inkjet heads to perform a sub scanning operation of moving relatively to the medium in a sub scanning direction orthogonal to the main scanning direction, wherein
when a row in which one or more inkjet heads are arranged side by side in the main scanning direction is defined as a head row, the inkjet heads are arranged so as to form a plurality of the head rows in which positions in the sub scanning direction are shifted,
the printing apparatus comprises at least inkjet heads for primary colors and inkjet heads for secondary colors as the inkjet heads, the primary colors being basic colors that enable color representation in principle by subtractive color mixing, the secondary colors being colors obtained by mixing a plurality of the primary colors in principle,
the printing apparatus comprises a dark ink head and a light ink head for at least one of red and blue as the inkjet heads for the secondary colors, the dark ink head being an inkjet head configured to eject ink of a relatively dark color, the light ink head being an inkjet head configured to eject ink of a relatively light color, and
the dark ink head for red or blue, and the light ink head for red or blue are arranged in different head rows.

2. The printing apparatus according to claim 1, further comprising:
An inkjet head for black color that is an inkjet head configured to eject ink of black color as any one of the inkjet heads; and
the dark ink head for black and the light ink head for black as the inkjet head for black color.

3. The printing apparatus according to claim 2, wherein the dark ink head for black and the light ink head for black are arranged in the same head row.

4. The printing apparatus according to claim 1, wherein
the inkjet heads for the secondary colors comprise the dark ink head and the light ink head for at least each of red, green, and blue, and
for each of red, green, and blue, the dark ink head and the light ink head for the same color are arranged in different head rows.

5. The printing apparatus according to claim 4, wherein
the dark ink heads for red, green, and blue are arranged in the same head row, and
the light ink heads for red, green, and blue are arranged in the same head row.

6. The printing apparatus according to claim 5, wherein at least one of the inkjet heads for the primary colors is arranged in the same head row as a head row of the dark ink heads for red, green, and blue or in the same head row as a head row of the light ink heads for red, green, and blue.

7. The printing apparatus according to claim 6, wherein all the inkjet heads for the primary colors are arranged in the same head row as a head row of the dark ink heads for red, green, and blue or in the same head row as a head row of the light ink heads for red, green, and blue.

8. The printing apparatus according to claim 1, the inkjet heads are arranged separately in four or less head rows.

9. The printing apparatus according to claim 1, wherein
the printing apparatus includes, as inkjet heads for the primary colors, a plurality of inkjet heads configured to eject ink of different primary colors, and
the printing apparatus includes, as an inkjet head for each of the primary colors, only an inkjet head for ink having one kind of density.

10. The printing apparatus according to claim 1, wherein when a total of amounts of ink ejected to positions on the medium during one main scanning operation is defined as a main scanning ink amount, and the main scanning ink amount for ejecting ink once to every ejection position of ink set in accordance with a printing resolution is defined as a main scanning ink amount of 100%, the arrangement of the inkjet heads forming the head rows allows the inkjet heads to eject ink to the medium such that the maximum main scanning ink amount is 100% or less.

11. The printing apparatus according to claim 1, wherein at least one of the inkjet heads for the primary colors is an inkjet head capable of setting at least two kinds of volumes as volumes of ink to be ejected.

12. A printing method for printing on a medium by inkjet, comprising:
controlling a plurality of inkjet heads, the plurality of inkjet heads are configured to eject ink to the medium to perform a main scanning operation of ejecting ink while moving relatively to the medium in a main scanning direction set in advance and perform a sub scanning operation of moving relatively to the medium in a sub scanning direction orthogonal to the main scanning direction, when a row in which one or more inkjet heads are arranged side by side in the main scanning direction is defined as a head row, the inkjet heads being arranged so as to form a plurality of the head rows in which positions in the sub scanning direction are shifted;
using at least inkjet heads for primary colors and inkjet heads for secondary colors as the inkjet heads, the primary colors being basic colors that enable color representation in principle by subtractive color mixing, the secondary colors being colors obtained by mixing a plurality of the primary colors in principle; and
using a dark ink head and a light ink head for at least one of red and blue as the inkjet head for the secondary colors, the dark ink head being an inkjet head configured to eject ink of a relatively dark color, the light ink head being an inkjet head configured to eject ink of a relatively light color, for the red or the blue, the dark ink head and the light ink head being arranged in different head rows.
